(19) United States
(12) Patent Application Publication
(10) Pub. No.: US 2025/0289745 A1
(43) Pub. Date: Sep. 18, 2025

(54) SEAL PLATE ASSEMBLY FOR GLASS FORMING ROLL

(71) Applicant: CORNING INCORPORATED, CORNING, NY (US)

(72) Inventor: Benjamin Logan Carl, Corning, NY (US)

(21) Appl. No.: 18/860,228

(22) PCT Filed: Apr. 26, 2023
(86) PCT No.: PCT/US2023/019899

§ 371 Date: Oct. 25, 2024

Related U.S. Application Data
(60) Provisional application No. 63/340,057, filed on May 10, 2022.

(51) Int. Cl. C03B 13/16; C03B 13/04

(52) U.S. Cl. CPC C03B 13/16; C03B 13/04

(57) ABSTRACT

An apparatus and method for positioning and receiving the shaft of a glass forming roll includes a rotatable member and a radially moveable member mounted on the rotatable member, the radially moveable member having a bore for receiving the shaft of the glass forming roll and movable between a first position and a second position, the first position closer to an axis of rotation of the rotatable member than the second position

### CROSS REFERENCE TO RELATED APPLICATION

This application claims the benefit of priority under 35 U.S.C. § 119 of U.S. Provisional Application Ser. No. 63/340,057 filed on May 10, 2022, the content of which is relied upon and incorporated herein by reference in its entirety.

### FIELD

The present disclosure relates generally to a seal plate assembly and more specially to a seal plate assembly for a glass forming roll.

### BACKGROUND

In the production of glass articles, such as glass sheets for display applications, including televisions and hand-held devices, such as telephones and tablets, molten glass can be formed into glass sheets by flowing the molten glass from a forming device. As the molten glass is cooled inside of a forming apparatus downstream of the forming device, it may be contacted by one or more forming rolls. Due to a need for a stable environment inside the forming apparatus, a sealing capability is desired where a forming roll shaft intersects a wall of the forming apparatus. In addition, maintenance of such sealing capability is desirable when the forming roll shaft is moved to a different position, such as during a process upset or a roll change.

### SUMMARY

Embodiments disclosed herein include an apparatus for receiving a shaft of a glass forming roll. The apparatus includes a rotatable member and a radially moveable member mounted on the rotatable member. The radially movable member includes a bore configured to receive the shaft of the glass forming roll and is movable between a first position and a second position, the first position closer to an axis of rotation of the rotatable member than the second position.

Embodiments disclosed herein also include a method for positioning a glass forming roll. The method includes receiving a shaft of the glass forming roll in an apparatus that includes a rotatable member and a radially moveable member mounted on the rotatable member. The radially movable member includes a bore configured to receive the shaft of the glass forming roll and is movable between a first position and a second position, the first position closer to an axis of rotation of the rotatable member than the second position.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic perspective end view of an example glass manufacturing apparatus that includes an opposing pair of forming rolls in accordance with embodiments disclosed herein;

FIG. 3 is a schematic perspective end view of an example glass manufacturing apparatus that includes a single forming roll in accordance with embodiments disclosed herein;

FIG. 4 is a schematic perspective end view of an example glass manufacturing apparatus that includes a single forming roll and an opposing pair of forming rolls in accordance with embodiments disclosed herein;

FIG. 5 is a schematic perspective side view of an example single forming roll mounted within a forming apparatus;

FIG. 6 is a schematic perspective end view of an apparatus for receiving the shaft of a glass forming roll in accordance with embodiments disclosed herein;

FIGS. 7A-7E are perspective views of components of an apparatus for receiving the shaft of a glass forming roll in accordance with embodiments disclosed herein; and

FIGS. 8A-8C are schematic perspective end views of an apparatus for receiving the shaft of a glass forming roll at various roll positions in accordance with embodiments disclosed herein.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “molten glass” refers to a glass composition that is at or above its liquidus temperature (the temperature above which no crystalline phase can coexist in equilibrium with the glass).

As used herein, the term “liquidus viscosity” refers to the viscosity of a glass composition at its liquidus temperature.

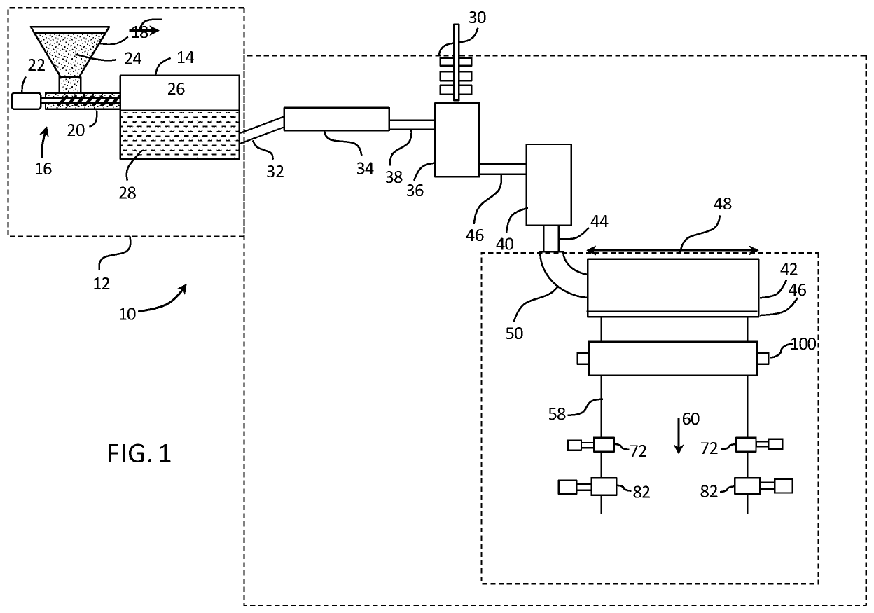

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to delivery device 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced delivery device 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Delivery device 42 in a slot draw glass making apparatus can comprise a delivery orifice (e.g., slot) 46 through which molten glass flows to produce a single glass ribbon 58 that is drawn in a draw or flow direction 60 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco elastic transition and acquires mechanical properties that give the glass ribbon 58 stable dimensional characteristics. Glass ribbon 58 may be contacted with an opposing pair of forming rolls 100 positioned downstream of delivery device 42.

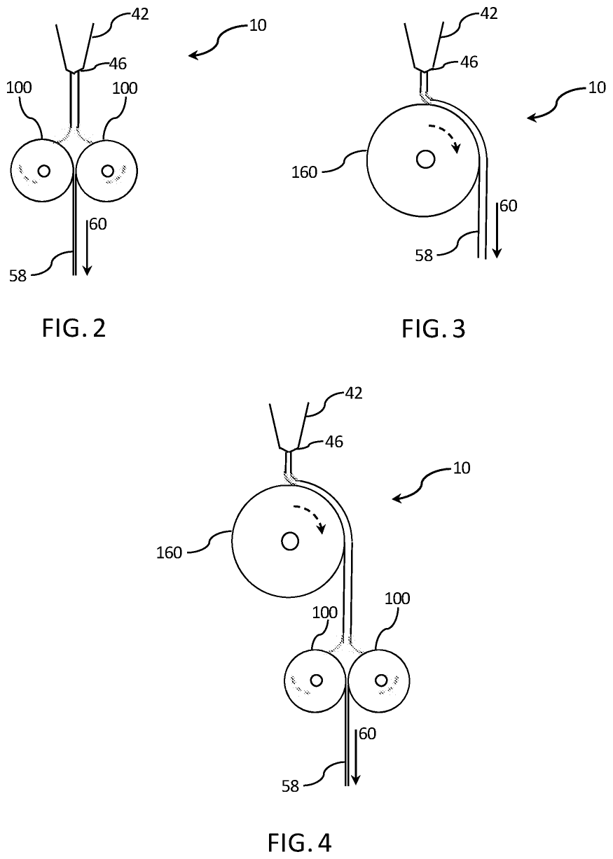

FIG. 2 shows a schematic perspective end view of an example glass manufacturing apparatus 10 that includes an opposing pair of forming rolls 100 in accordance with embodiments disclosed herein. Specifically, FIG. 2 shows flowing molten glass through delivery orifice (e.g. slot) 46 of glass delivery device 42 in draw direction 60 to form glass ribbon 58. In addition, FIG. 2 shows contacting opposing sides of glass ribbon 58 with an opposing pair of forming rolls 100 positioned downstream of glass delivery device 42 in draw direction 60, each forming roll 100 of the opposing pair extending along the widthwise direction of opposing sides of glass ribbon 58. Each of the forming rolls 100 may, for example, rotate in the clockwise direction (as indicated by dashed, curved arrows).

FIG. 3 shows a schematic perspective end view of an example glass manufacturing apparatus 10 that includes a single forming roll 160 in accordance with embodiments disclosed herein. Specifically, FIG. 3 shows flowing molten glass through delivery orifice (e.g. slot) 46 of glass delivery device 42 in draw direction 60 to form glass ribbon 58. In addition, FIG. 3 shows contacting a first side of glass ribbon 58 with a single forming roll 160 positioned downstream of glass delivery device 42, in draw direction 60, single forming roll 160 extending along the widthwise direction of a first side of glass ribbon 58. Single forming roll 160 may, for example, rotate in the clockwise direction (as indicated by dashed, curved arrow).

FIG. 4 shows a schematic perspective end view of an example glass manufacturing apparatus 10 that includes a single forming roll 160 and an opposing pair of forming rolls 100 in accordance with embodiments disclosed herein. Specifically, FIG. 4 shows flowing molten glass through delivery orifice (e.g. slot) 46 of glass delivery device 42 in draw direction 60 to form glass ribbon 58. In addition, FIG. 4 shows contacting a first side of glass ribbon 58 with a single forming roll 160 positioned downstream of glass delivery device 42, in draw direction 60 and further contacting opposing sides of glass ribbon 58 with an opposing pair of forming rolls 100 positioned downstream of single forming roll 160 in draw direction 60.

In certain exemplary embodiments, wherein glass manufacturing apparatus 10 comprises single forming roll 160, a viscosity of the glass ribbon 58 prior to contacting the forming roll 160 ranges from about 1 poise (P) to about 10 kilopoise (kP), such as from about 10 poise (P) to about 1 kilopoise (kP), and the viscosity of the glass ribbon 58 subsequent to contacting the forming roll 160 ranges from about 50 kilopoise (kP) to about 500 kilopoise (kP), such as from about 100 kilopoise (kP) to about 200 kilopoise (kP).

In certain exemplary embodiments, single forming roll 160 can be configured in accordance with forming rolls shown and described in WO2009/070236, the entire disclosure of which is incorporated herein by reference. Single forming roll 160 can be configured so as to provide a controllable adhesion force between the forming roll 160 and the glass ribbon 58. The diameter of single forming roll 160, while not limited to any particular value, may, for example, range from about 50 millimeters to about 500 millimeters and all ranges and subranges in between. In addition, single forming roll 160 may comprise a refractory material, which, while not limited to any particular refractory material, may comprise a metallic material (e.g., stainless steel and/or nickel and/or cobalt-based alloys and/or nickel-chromium based superalloys, e.g., Inconel) and/or a refractory ceramic material.

In certain exemplary embodiments, forming rolls 100 can be configured in accordance with forming rolls shown and described in WO2009/070236, the entire disclosure of which is incorporated herein by reference. The diameter of forming rolls 100 while not limited to any particular value, may, for example, range from about 20 millimeters to about 400 millimeters and all ranges and subranges in between. In addition, forming rolls 100 may comprise a refractory material, which, while not limited to any particular refractory material, may comprise a metallic material (e.g., stainless steel and/or nickel and/or cobalt-based alloys and/or nickel-chromium based superalloys, e.g., Inconel) and/or a refractory ceramic material.

Delivery device 42 may, for example, be comprised of a refractory which, while not limited to any particular refractory material, may comprise a metallic material (e.g., platinum or an alloy thereof) and/or a refractory ceramic material. In certain exemplary embodiments, delivery device 42 can be configured in accordance with delivery devices shown and described in WO2020/033387, the entire disclosure of which is incorporated herein by reference.

A closest distance between delivery device 42 (e.g., delivery orifice 46) and single forming roll 160, while not limited to any particular value, may, for example, range from about 2 millimeters to about 5 meters and all ranges and subranges in between.

A closest distance between delivery device 42 (e.g., delivery orifice 46) and forming rolls 100 at their closest point (i.e., their nip distance), while not limited to any particular value, may, for example, range from about 2 millimeters to about 5 meters and all ranges and subranges in between.

In certain exemplary embodiments, molten glass flowing from delivery device 42 can comprise a liquidus viscosity of less than or equal to about 100 kilopoise (kP), such as a liquidus viscosity ranging from about 100 poise (P) to about 100 kilopoise (kP), and further such as a liquidus viscosity ranging from about 500 poise (P) to about 50 kilopoise (kP), and yet further such as a liquidus viscosity ranging from about 1 kilopoise (kP) to about 20 kilopoise (kP) and all ranges and subranges in between.

In certain exemplary embodiments, molten glass flowing from forming device (e.g., delivery device 42) can comprise a liquidus temperature of greater than or equal to about 900° C., such as a liquidus temperature ranging from about 900° C. to about 1,450° C., and further such as a liquidus temperature ranging from about 950° C. to about 1,400° C., and yet further such as a liquidus temperature ranging from about 1,000° C. to about 1,350° C.

In certain exemplary embodiments, incident and/or subsequent to contact with at least one forming rolls 160 or 100, glass ribbon 58 has a thickness of less than about 0.5 millimeters, such as a thickness of less than about 0.4 millimeters, and further such as a thickness of less than about 0.3 millimeters, and yet further such as a thickness of less than about 0.2 millimeters, such as a thickness of from about 0.1 millimeters to about 0.5 millimeters, including a thickness of about 0.2 millimeters to about 0.4 millimeters.

FIG. 5 shows a schematic perspective side view of an example single forming roll 160 mounted within forming apparatus 48. Forming roll includes shafts 162 that extend through walls 202 of forming apparatus 48.

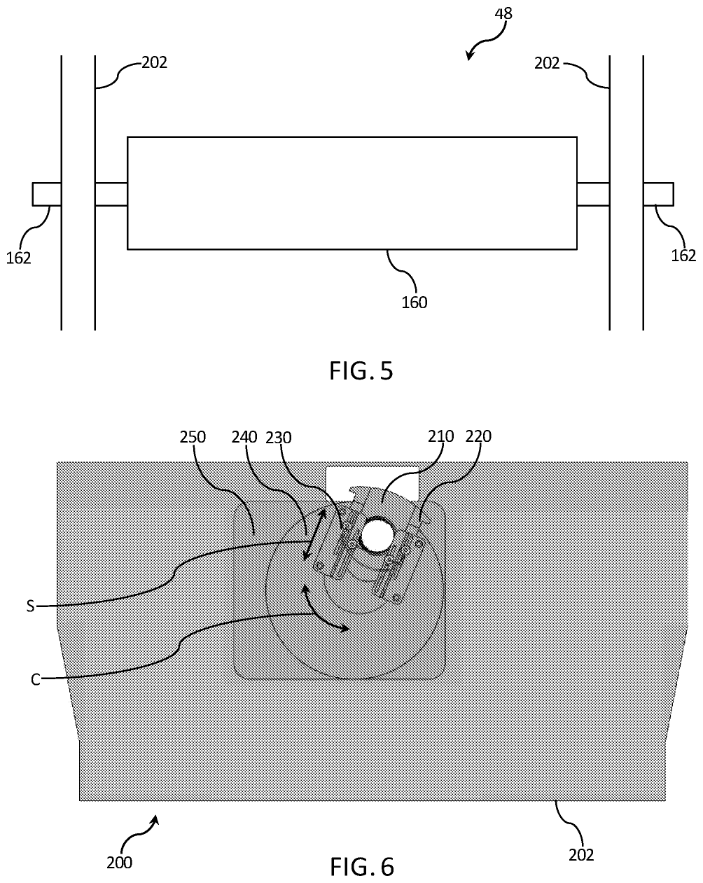

FIG. 6 shows a schematic perspective end view of an apparatus 200 for receiving the shaft 162 of a glass forming roll (e.g., single forming roll 160, etc.) in accordance with embodiments disclosed herein. Apparatus 200 includes wall 202 of forming apparatus 48 and base member 250 mounted thereon. Apparatus 200 further includes rotatable member 240 mounted on base member 250. In addition, apparatus 200 includes radially moveable member 210 mounted on rotatable member 240 via intermediate member 220, wherein radially movable member 210 is slidably mounted on intermediate member 220 via adjustment member 230.

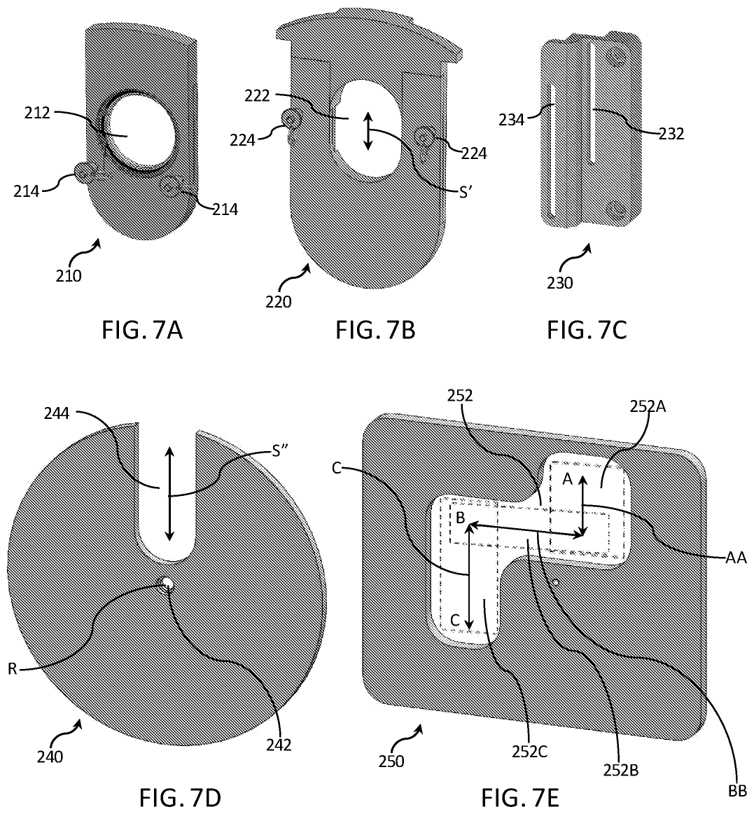

As shown in FIG. 6, radially moveable member 210 can be moved relative to an axis of rotation (shown as ‘R’ in FIG. 7D) of rotatable member 240. Specifically, as shown by arrow ‘S’ in FIG. 6, radially moveable member 210 is movable between a first position closer to the axis of rotation of the rotatable member 240 and a second position farther from the axis of rotation of the rotatable member 240. Meanwhile, as shown by arrow ‘C’ in FIG. 6, rotatable member 240 is rotatably moveable (e.g., in the clockwise or counterclockwise directions) between different rotation positions.

FIGS. 7A-7E show perspective views of components of apparatus 200 for receiving the shaft 162 of a glass forming roll in accordance with embodiments disclosed herein. Specifically, FIG. 7A shows a perspective view of a radially moveable member 210 in accordance with embodiments disclosed herein. Radially moveable member 210 includes bore 212 for receiving shaft 162 of glass forming roll (e.g., single forming roll 160, etc.). Radially moveable member 210 also includes mounting pins 214.

FIG. 7B shows a perspective view of an intermediate member 220 in accordance with embodiments disclosed herein. Intermediate member 220 includes elongated bore 222 for receiving the shaft 162 of the glass forming roll between first position closer to the axis of rotation of rotatable member 240 and a second position farther from the axis of rotation of rotatable member 240. Intermediate member 220 also includes mounting pins 224. Relative movement of shaft 162 within elongated bore 222 is shown in FIG. 7B by arrow ‘S’′.

FIG. 7C shows a perspective view of an adjustment member 230 in accordance with embodiments disclosed herein. Adjustment member 230 includes first slots 232 for receiving mounting pins 214 of radially moveable member 210 and second slots 234 for receiving mounting pins 224 of intermediate member 220. Accordingly, due to allowance of movement of mounting pins 214 relative to first slots 232, radially moveable member 210 is slidably mounted on intermediate member 220 via adjustment member 230. In addition, due to allowance of movement of mounting pins 224 relative to second slots 234, intermediate member 220 is slidably mounted on rotatable member 240 via adjustment member 230. Accordingly, both radially moveable member 210 and intermediate member 220 are movable relative to rotatable member 240 between positions that are closer and farther from the axis of rotation of rotatable member 240.

FIG. 7D shows a perspective view of a rotatable member 240 in accordance with embodiments disclosed herein. Rotatable member 240 includes a central bore 242 extending through and around its axis of rotation ‘R’. Rotatable member 240 also includes a slotted opening 244 for receiving the shaft 162 of the glass forming roll between first position closer to the axis of rotation of rotatable member 240 and a second position farther from the axis of rotation of rotatable member 240. Relative movement of shaft 162 within slotted opening 244 is shown in FIG. 7D by arrow ‘S’″.

FIG. 7E shows a perspective view of a base member 250 in accordance with embodiments disclosed herein. Base member 250 includes interior bore 252 for receiving the shaft 162 of the glass forming roll between different positions. Specifically, interior bore 252 includes a first region 252A extending along a first path ‘AA,’ a second region 252B extending along a second path ‘BB,’ and a third region 252C extending along a third path ‘CC.’

In certain exemplary embodiments, first path ‘AA,’ and second path ‘BB,’ are configured to receive the shaft 162 of the glass forming roll between a first rotation position ‘A’ and a second rotation position ‘B’ that is rotationally offset from the first rotation position ‘A’ while third path ‘CC’ is configured to receive the shaft 162 of the glass forming roll between the second rotation position ‘B’ and a third rotation position ‘C’ that is rotationally offset from the first rotation position ‘A’ and the second rotation position ‘B.’ As shown in FIG. 7E, first path ‘AA’ is generally parallel to third path ‘CC’ and generally perpendicular to second path ‘BB.’

Movement of shaft 162 between different positions ‘A,’ ‘B,’ and/or ‘C’ can be accomplished while rotating rotatable member 240 relative to base member 250 and while also moving radially movable member 210 and/or intermediate member 220 relative to rotatable member 240. Movement of such members can be accomplished simultaneously by moving shaft 162 between positions ‘A,’ ‘B,’ and/or ‘C’ via a shaft movement mechanism, for example a motor, such as a servo motor, in communication with a control mechanism according to methods known to persons having ordinary skill in the art.

And while FIG. 7E shows base member 250 having interior bore 252 with first, second, and third regions, 252A, 252B, and 252C, embodiments disclosed herein include those in which interior bore 252 has different geometries than that shown in FIG. 7E, which can, for example, allow for movement of shaft 162 to positions other than those shown in FIG. 7E. For example, while FIG. 7E, shows a first path ‘AA’ that is generally parallel to a third path ‘CC’ and generally perpendicular to a second path ‘BB,’ embodiments disclosed herein include those in which paths of movement include more or less than three paths and/or extend in a variety of directions relative to each other (e.g., not only at right angles but also at acute or obtuse angles relative to each other).

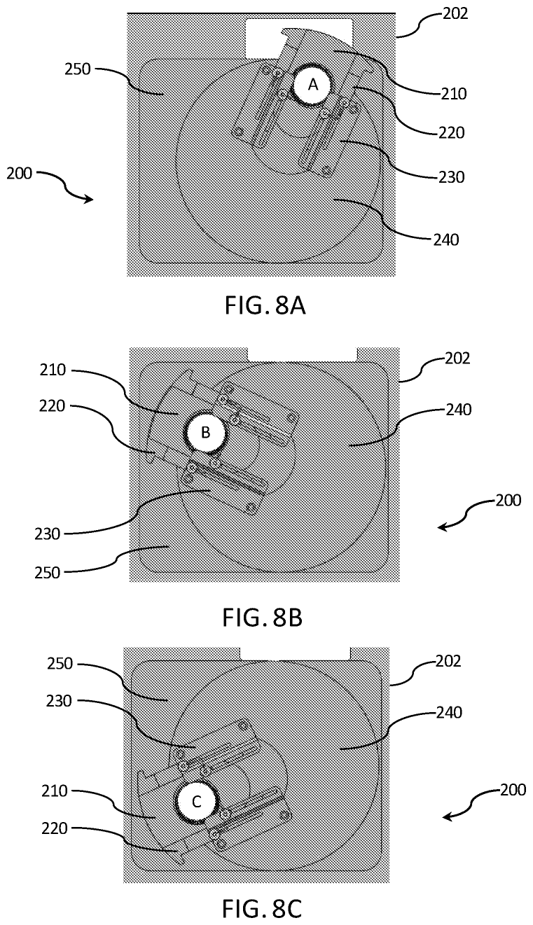

FIGS. 8A-8C show schematic perspective end views of an apparatus 200 for receiving the shaft 162 of a glass forming roll at various roll positions in accordance with embodiments disclosed herein. Specifically, FIG. 8A shows a schematic perspective end view of apparatus 200 wherein shaft 162 is at first rotation position ‘A,’ FIG. 8B shows a schematic perspective end view of apparatus 200 wherein shaft 162 is at second rotation position ‘B,’ and FIG. 8C shows a schematic perspective end view of apparatus 200 wherein shaft 162 is at third rotation position ‘C.’

In certain exemplary embodiments, first rotation position ‘A’ is rotationally offset from second rotation position ‘B’ by at least about 50 degrees, such as at least about 70 degrees, and further such as at least about 90 degrees, such as from about 50 degrees to about 100 degrees, and second rotation position ‘B’ is rotationally offset from the third rotation position ‘C’ by at least about 30 degrees, such as at least about 40 degrees, and further such as at least about 50 degrees, such as from about 30 degrees to about 60 degrees. In certain exemplary embodiments, first rotation position ‘A’ is rotationally offset from third rotation position ‘C’ by at least about 80 degrees, such as at least about 100 degrees, and further such as at least about 120 degrees, such as from about 80 degrees to about 160 degrees.

In certain exemplary embodiments, one or more components of apparatus 200, such as radially moveable member 210, intermediate member 220, adjustment member 230, rotatable member 240, and/or base member 250 may comprise a low friction material, such as a low friction metallic material including, for example, a low friction steel such as Nitronic 60 stainless steel.

Embodiments disclosed herein can enable a more stable environment inside of a glass forming apparatus 48 due to the sealing capability that can be maintained when one or more components of apparatus 200 are moved relative to each other when shaft 162 of a glass forming roll is moved between different positions, such as during a process upset or a roll change. This can, in turn, more efficiently enable the reliable production of glass articles with desired attributes.

While the above embodiments have been described with reference to a slot draw process, it is to be understood that such embodiments are also applicable to other glass forming processes, such as fusion draw processes, float processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

What is claimed is:

1. An apparatus for receiving a shaft of a glass forming roll comprising:
a rotatable member; and
a radially moveable member mounted on the rotatable member, the radially movable member comprising a bore configured to receive the shaft of the glass forming roll and movable between a first position and a second position, the first position closer to an axis of rotation of the rotatable member than the second position.

2. The apparatus of claim 1, wherein the radially moveable member is mounted to the rotatable member via an intermediate member, the intermediate member comprising an elongated bore configured to receive the shaft of the glass forming roll between the first position and the second position.

3. The apparatus of claim 2, wherein the radially moveable member is slidably mounted on the intermediate member via an adjustment member.

4. The apparatus of claim 3, wherein the adjustment member comprises a first slot configured to receive a mounting pin of the radially moveable member and a second slot configured to receive a mounting pin of the intermediate member.

5. The apparatus of claim 1, wherein the rotatable member comprises a slotted opening configured to receive the shaft of the glass forming roll between the first position and the second position.

6. The apparatus of claim 1, wherein the rotatable member is mounted on a base member, the base member comprising an interior bore configured to receive the shaft of the glass forming roll between a first rotation position and a second rotation position that is rotationally offset from the first rotation position.

7. The apparatus of claim 6, wherein the interior bore comprises a first region extending along a first path, a second region extending along a second path, and a third region extending along a third path, wherein the first and second paths are configured to receive the shaft of the glass forming roll between the first rotation position and the second rotation position and the third path is configured to receive the shaft of the glass forming roll between the second rotation position and a third rotation position that is rotationally offset from the first and second rotation positions.

8. The apparatus of claim 7, wherein the first path is generally parallel to the third path and generally perpendicular to the second path.

9. The apparatus of claim 7, wherein the first rotation position is rotationally offset from the second rotation position by at least about 50 degrees and the second rotation position is rotationally offset from the third rotation position by at least about 30 degrees.

10. A method for positioning a glass forming roll comprising:
receiving a shaft of the glass forming roll in an apparatus comprising:
a rotatable member: and
a radially moveable member mounted on the rotatable member, the radially movable member comprising a bore configured to receive the shaft of the glass forming roll and movable between a first position and a second position farther from the axis of rotation of the rotatable member than the first position.

11. The method of claim 10, wherein the radially moveable member is mounted to the rotatable member via an intermediate member, the intermediate member comprising an elongated bore configured to receive the shaft of the glass forming roll between the first position and the second position.

12. The method of claim 11, wherein the radially moveable member is slidably mounted on the intermediate member via an adjustment member.

13. The method of claim 12, wherein the adjustment member comprises a first slot configured to receive a mounting pin of the radially moveable member and a second slot configured to receive a mounting pin of the intermediate member.

14. The method of claim 10, wherein the rotatable member comprises a slotted opening configured to receive the shaft of the glass forming roll between the first position and the second position.

15. The method of claim 10, wherein the rotatable member is mounted on a base member, the base member comprising an interior bore configured to receive the shaft of the glass forming roll between a first rotation position and a second rotation position that is rotationally offset from the first rotation position.

16. The method of claim 15, wherein the interior bore comprises a first region extending along a first path, a second region extending along a second path, and a third region extending along a third path, wherein the first and second paths are configured to receive the shaft of the glass forming roll between the first rotation position and the second rotation position and the third path is configured to receive the shaft of the glass forming roll between the second rotation position and a third rotation position that is rotationally offset from the first and second rotation positions.

17. The method of claim 16, wherein the first path is generally parallel to the third path and generally perpendicular to the second path.

18. The method of claim 16, wherein the first rotation position is rotationally offset from the second rotation position by at least about 50 degrees and the second rotation position is rotationally offset from the third rotation position by at least about 30 degrees.

19. The method of claim 10, further comprising radially moving the radially moveable member between the first position and the second position.

20. The method of claim 16, further comprising rotating the rotatable member between at least one of the first rotation position, the second rotation position, or the third rotation position.
